(19) United States
(12) Patent Application Publication
(10) Pub. No.: US 2023/0034018 A1
(43) Pub. Date: Feb. 2, 2023

(54) ELECTRONIC DEVICE COMPRISING WIRELESS COMMUNICATION CIRCUIT FOR BLUETOOTH COMMUNICATION, AND METHOD FOR OPERATING SAME

(71) Applicant: Samsung Electronics Co., Ltd., Suwon-si (KR)

(72) Inventors: Gupil CHEONG, Suwon-si (KR); Donghyeon KIM, Suwon-si (KR); Hasik MOON, Suwon-si (KR); Byoungchul LEE, Suwon-si (KR); Kyungik JANG, Suwon-si (KR); Doosuk KANG, Suwon-si (KR); Bokun CHOI, Suwon-si (KR)

(21) Appl. No.: 17/964,221

(22) Filed: Oct. 12, 2022

Related U.S. Application Data
(63) Continuation of application No. PCT/KR2021/004723, filed on Apr. 14, 2021.

(30) Foreign Application Priority Data
Apr. 14, 2020 (KR) 10-2020-0045164
Apr. 14, 2021 (KR) 10-2021-0048807

(51) Int. Cl. H04W 4/38; H04W 4/80; H04W 8/00

(52) U.S. Cl. CPC H04W 4/38; H04W 4/80; H04W 8/005

(57) ABSTRACT

An electronic device is provided. The electronic device includes a wireless communication circuit configured to perform Bluetooth communication, a sensor, a connection terminal for connection with a first external electronic device, a processor operatively connected to the sensor and the wireless communication circuit, and memory operatively connected to the processor. The memory may store instructions which, when executed, enable the processor to: determine by means of the sensor whether a cover of the first external electronic device is open or closed, if it is determined that the cover of the first external electronic device is open, determine whether or not the connection terminal is electrically connected to the first external electronic device, and, if it is determined that the connection terminal is connected to the first external electronic device, switch the wireless communication circuit to an inquiry scan enable mode.

### CROSS-REFERENCE TO RELATED APPLICATION(S)

This application is a continuation application, claiming priority under § 365(c), of an International application No. PCT/KR2021/004723, filed on Apr. 14, 2021, which is based on and claims the benefit of a Korean patent application number 10-2020-0045164, filed on Apr. 14, 2020, in the Korean Intellectual Property Office, and of a Korean patent application number 10-2021-0048807, filed on Apr. 14, 2021, in the Korean Intellectual Property Office, the disclosure of each of which is incorporated by reference herein in its entirety.

### BACKGROUND

### 1. Field

The disclosure relates to an electronic device comprising a wireless communication circuit for Bluetooth communication and a method for operating the same.

### 2. Description of Related Art

The Bluetooth standard technology defined by the Bluetooth special interest group (Bluetooth SIG) defines a protocol for short-range wireless communication between electronic devices. In a Bluetooth network environment, electronic devices may transmit or receive data packets containing content, such as text, voice, images, or video, in a specified frequency band (e.g., about 2.4 gigahertz (GHz)).

For example, user equipment (UE), such as a smailphone, a tablet, a desktop computer, or a laptop computer, may transmit data packets to other user equipment or accessory devices via the Bluetooth network environment. The accessory device may include, for example, at least one of earphones, a headset, a speaker, a mouse, a keyboard, a charger, or a display device.

The above information is presented as background information only to assist with an understanding of the disclosure. No determination has been made, and no assertion is made, as to whether any of the above might be applicable as prior art with regard to the disclosure.

### SUMMARY

When a user connects a Bluetooth electronic device to a first external electronic device and wants to connect the Bluetooth electronic device to another external electronic device while using the Bluetooth electronic device, it may be necessary to enter an inquiry stage.

The Bluetooth electronic device may place a physical button on the Bluetooth electronic device or a case (e.g., a charging case) of the Bluetooth electronic device in order to support the inquiry scan enable/disable switching. When an external operation button of the Bluetooth electronic device is mounted like the existing Bluetooth electronic devices, the physical size of the Bluetooth electronic device may increase. When a physical button is used on the case of the Bluetooth electronic device, the case and the Bluetooth electronic device have to perform additional communication for the user's button operation of the case, which may lead to the regulation of the communication method, current consumption, or additional circuit configuration.

Aspects of the disclosure are to address at least the above-mentioned problems and/or disadvantages and to provide at least the advantages described below. Accordingly, an aspect of the disclosure is to provide a Bluetooth electronic device and a method for operating the same capable of entering a pairing mode through an easy operation method without a physical button or an operation method that is difficult for a user to recognize, or a separate communication with a case.

Additional aspects will be set forth in part in the description which follows and, in part, will be apparent from the description, or may be learned by practice of the presented embodiments.

In accordance with an aspect of the disclosure, an electronic device (210) is provided. The electronic device includes a wireless communication circuit configured to perform Bluetooth communication, a sensor, a connection terminal configured to connect with a first external electronic device, a processor operatively connected to the sensor and the wireless communication circuit, and a memory operatively connected to the processor, in which the memory may store instructions that, when executed, cause the processor to determine by means of the sensor whether a cover of the first external electronic device is open, determine whether or not the connection terminal is electrically connected to the first external electronic device if it is determined that the cover of the first external electronic device is open, and, switch the wireless communication circuit to an inquiry scan enable mode if it is determined that the connection terminal is connected to the first external electronic device.

In accordance with another aspect of the disclosure, an electronic device is provided. The electronic device includes a wireless communication circuit configured to perform Bluetooth communication, a sensor, a connection terminal configured to connect with a first external electronic device, a processor operatively connected to the sensor and the wireless communication circuit, and a memory operatively connected to the processor, in which the memory stores instructions that, when executed, cause the processor to determine by means of the sensor whether a cover of the first external electronic device is open, determine whether or not the connection terminal is electrically connected to the first external electronic device if it is determined that the cover of the first external electronic device is open, and transmit, by means of the wireless communication circuit, information about whether the electronic device and the first external electronic device are electrically connected to each other to the second external electronic device connected to the electronic device through a first communication link, if it is determined that the connection terminal is in a state of being connected to the first external electronic device.

In accordance with another aspect of the disclosure, a method for operating an electronic device including a wireless communication circuit for Bluetooth communication is provided. The method includes determining by means of a sensor of the electronic device whether a cover of a first external electronic device is open, determining whether a connection terminal of the electronic device is electrically connected to the first external electronic device if it is determined that the cover of the first external electronic device is open, and performing switching to an inquiry scan enable mode if it is determined that the connection terminal is connected to the first external electronic device.

According to various embodiments disclosed in the disclosure, an electronic device enters the inquiry scan enable mode if a specific condition is satisfied, thereby easily entering the inquiry scan enable mode without an increase in the size of the electronic device or separate communication with the case, and thus it is possible to provide an electronic device with increased usability and convenience.

According to various embodiments of the disclosure, the electronic device may selectively respond to an inquiry request from an external electronic device, thereby providing a Bluetooth connection with an external electronic device that matches the intention of a user with higher accuracy.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a diagram schematically showing a structure of Bluetooth electronic devices constituting one set according to an embodiment of the disclosure;

FIG. 3 is a diagram schematically illustrating a structure of a third electronic device according to an embodiment of the disclosure;

FIG. 4 is a flowchart illustrating an operation of a first electronic device according to an embodiment of the disclosure;

FIG. 5 is a flowchart illustrating an operation of a second electronic device according to an embodiment of the disclosure;

FIG. 6 is a diagram for describing an operation of the first electronic device according to an embodiment of the disclosure;

FIG. 7 is a flowchart illustrating an operation of a third electronic device according to an embodiment of the disclosure;

FIG. 8 is a block diagram illustrating a configuration of the third electronic device according to an embodiment of the disclosure; and

FIG. 9 is a flowchart illustrating an operation of the first electronic device according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the disclosure. Accordingly, it should be apparent to those skilled in the art that the following description of various embodiments of the disclosure is provided for illustration purposes only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

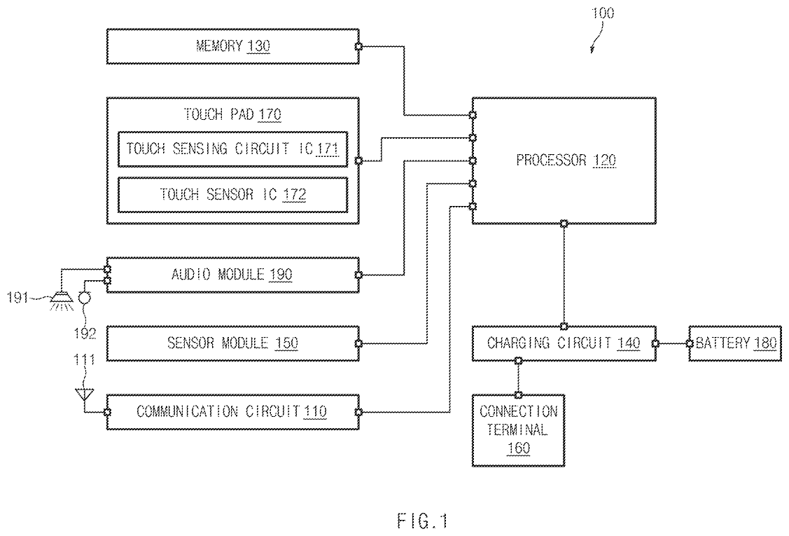

Hereinafter, a configuration of an electronic device according to an embodiment will be described with reference to FIG. 1.

FIG. 1 is a block diagram of an electronic device 100, according to an embodiment of the disclosure.

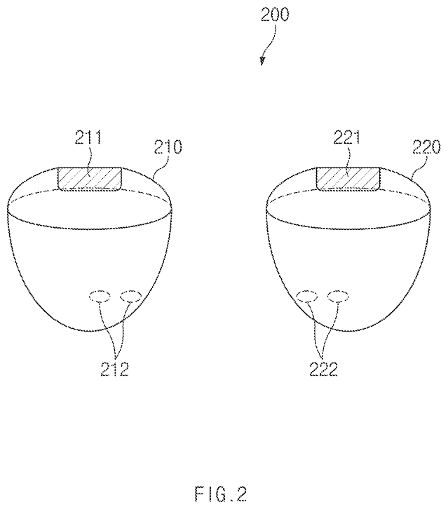

Referring to FIG. 1, the electronic device 100 (e.g., a first electronic device 210 or second electronic device 220 of FIG. 2) may include a communication circuit 110, at least one antenna 111, a processor 120, a memory 130, a charging circuit 140, a sensor module 150, a connection terminal 160, a touch pad 170, a battery 180, an audio module 190, a speaker 191, or a microphone 192. According to various embodiments of the disclosure, in the electronic device 100, at least one of the components in FIG. 1 may be omitted, or one or more other components may be added. In addition, some of the components may be implemented as single integrated circuitry.

The processor 120 may execute software to control at least one other component (e.g., a hardware or software component) of the electronic device 100 coupled with the processor 120 and perform various data processing or computation. As at least part of the data processing or computation, the processor 120 may load a command or data received from another component (e.g., the sensor module 150 or the communication circuit 110) in a volatile memory of the memory 130, process the command or the data stored in the volatile memory, and store resulting data in a non-volatile memory.

The memory 130 may store various data to be used, by at least one component (e.g., the processor 120 or the sensor module 150) of the electronic device 100. The various data may include, for example, software (e.g., the program) and input data or output data for a command related thereto. The memory 130 may include a volatile memory or a nonvolatile memory. The program may be stored in the memory 130 as software, and may include, for example, an operating system (OS), middleware, or an application. The memory 130 may store, for example, instructions related to various operations performed by the processor 120.

The touch pad 170 is a pointing device utilizing one surface of a housing of the electronic device 100 and may include a touch sensing circuit 171 and a touch sensor integrated circuit (IC) (or touch sensor) 172. According to an embodiment of the disclosure, the touch sensing circuit 171 may include a conductive pattern located in the housing. A non-conductive cover may be implemented in the housing of the electronic device 100 and may be positioned to overlap the touch sensing circuit 171 at least in part. The cover including the conductive pattern located in the housing may be utilized as an input region (or key region) for receiving or sensing a user input. According to an embodiment of the disclosure, the touch pad 170 may be implemented based on a capacitive method. The touch sensor IC 172 (e.g., a touch controller integrated circuit (IC)) may apply a voltage to the touch sensing circuit 171, and the touch sensing circuit 171 may form an electromagnetic field. For example, if a finger of the user comes into contact with one surface of the cover implemented in the housing of the electronic device 100 or reaches within a threshold distance from the one surface of the cover, the change in capacitance based on the change in the electromagnetic field may be equal to or greater than a threshold value. When the change in capacitance is equal to or greater than the threshold value, the touch sensor IC 172 may generate an electrical signal regarding coordinates as a valid user input and transfer it to the processor 120. The processor 120 may recognize the coordinates based on the electrical signal received from the touch sensor IC 172. The touch sensing circuit 171 and the touch sensor IC 172 may also be collectively referred to as a sensor circuit for sensing a touch. According to various embodiments, the key region included on one surface of the non-conductive cover and the touch sensing circuit 171 corresponding to the key region may be collectively referred to as a “touch key”. The touch pad 170 may contribute to the appearance of the electronic device 100 having a sense of unity with a smooth design by forming a touch sensing circuit so as to conform to the shape of the housing.

The touch sensor IC 172 may convert an analog signal obtained through the touch sensing circuit 171 into a digital signal. The touch sensor IC 172 may perform various functions such as noise filtering, noise removal, or sensing data extraction in relation to the touch sensing circuit 171. The touch sensor IC 172 may include various circuits such as an analog-digital converter (ADC), a digital signal processor (DSP), and/or a micro control unit (MCU).

A user input regarding audio data (or audio content) may be generated through the touch pad 170. For example, functions such as playback start, playback pause, playback stop, playback speed control, playback volume control, or muting of audio data may be executed based on a user input through the touch pad 170. The electronic device 100 may receive various gesture inputs through a key region located on one surface of the electronic device 100 using a finger, various functions related to audio data may be implemented based on the gesture inputs. For example, if a single tap is performed in the key region, the processor 120 may play back the audio data or pause the playback. For example, if two taps are performed in the key region, the processor 120 may switch the playback to the next audio data. For example, if three taps are performed in the key region, the processor 120 may switch the playback to the previous audio data. For example, if swiping is performed in the key region, the processor 120 may adjust the volume related to the playback of audio data. The gesture input may be utilized not only for functions related to audio data, but also for various other functions. For example, when an incoming call comes in, if two taps are performed in the key region, the processor 120 may connect the call.

The touch pad 170 may further include a tactile layer (not shown). The touch pad 170 including the tactile layer may provide a tactile response to the user.

According to an embodiment of the disclosure, there may be a click button (not shown) aligned with the touch pad 170, and when the click button is pressed, an input such as clicking a mouse button may be generated. The touch pad 170 may include a sensor circuit (e.g., a pressure sensor) (not shown) configured to measure the strength of a force generated by a user input.

According to various embodiments of the disclosure, the electronic device 100 is not limited to the touch pad 170, and may further include various other input devices for receiving, from the outside (e.g., the user) of the electronic device 100, commands or data to be used in a component (e.g., the processor 120) of the electronic device 100. The input device may be various, for example, a physical button, or an optical key.

The speaker 191 may output an audio signal to the outside of the electronic device 100. Sound waves such as sound or voice may be introduced into the microphone 192 through the microphone hole, and the microphone 192 may generate an electrical signal therefor. The audio module 190 may convert a sound into an electrical signal and vice versa. The audio module 190 may acquire a sound through the microphone 192 or may output a sound through the speaker 191.

The audio module 190 may support an audio data collection function. The audio module 190 may play back the collected audio data. The audio module 190 may include an audio decoder, a digital-to-analog converter (D/A converter), or an analog-to-digital converter (A/D converter). The audio decoder may convert audio data stored in the memory 130 into a digital audio signal. The D/A converter may convert the digital audio signal converted by the audio decoder into an analog audio signal. The speaker 191 may output the analog audio signal converted by the D/A converter. The A/D converter may convert an analog audio signal acquired through the microphone 192 into a digital audio signal.

The sensor module 150 may detect, for example, an operational state (e.g., power or temperature) of the electronic device 100 or an environmental state (e.g., a state of the user) external to the electronic device 101, and may generate an electrical signal or data value corresponding to the detected state. The sensor module 150 may include an acceleration sensor, a gyro sensor, a geomagnetic sensor, a magnetic sensor, a proximity sensor, a temperature sensor, a gesture sensor, a grip sensor, or a biometric sensor.

For example, the electronic device 100 may include an optical sensor located at least partially inside the housing or on one surface of the housing. When the optical sensor is located inside the housing, a portion of the housing facing the optical sensor may be formed to allow light to pass through or may include an opening. The optical sensor may include a light emitting unit (e.g., a light emitting diode (LED)) that outputs light of at least one wavelength band, or a light receiving unit (e.g., a photodiode) that receives light of one or more wavelength bands and generates an electrical signal. According to an embodiment of the disclosure, the optical sensor may be a sensor for sensing wearing. According to an embodiment of the disclosure, the optical sensor may be a biometric sensor. In a state where the electronic device 100 is worn on the user's ear, light output from the light emitting unit of the optical sensor may be reflected from the user's skin and may be introduced into the light receiving unit of the optical sensor. The light receiving unit of the optical sensor may provide an electrical signal based on the introduced light to the processor 120. The processor 120 may transmit an electrical signal acquired from the optical sensor to an external electronic device (e.g., a smartphone) through the communication circuit 110. The external electronic device may acquire various biometric information, such as a heart rate or skin temperature, based on the electrical signal acquired from the electronic device 100. The processor 120 may acquire biometric information based on an electrical signal acquired from the optical sensor, and may transmit the acquired biometric information to an external electronic device through the communication circuit 110 or output it through the speaker 191.

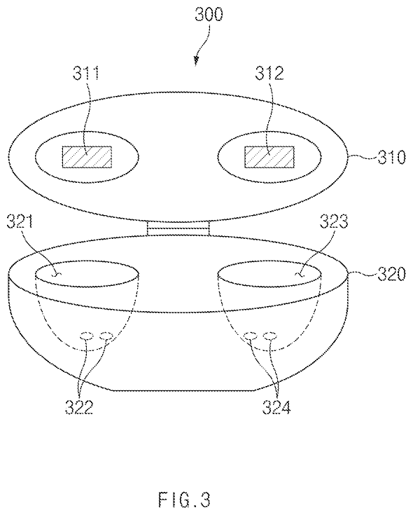

Information or a signal regarding whether the electronic device 100 is coupled to the user's ear may be acquired through the sensor module 150. Information or a signal regarding whether the electronic device 100 is coupled to an external device (e.g., a charging device of the electronic device 100) (e.g., a third electronic device 300 of FIG. 3) through the sensor module 150 may be acquired.

According to various embodiments of the disclosure (not shown), the electronic device 100 may include a member to be sensed (e.g., a first sensor 211 of FIG. 2) corresponding to a sensor (e.g., a third sensor 311 and/or a fourth sensor 312 of FIG. 3) of an external electronic device (e.g., the charging device of the electronic device 100). For example, the external electronic device may include a Hall IC disposed in a mounting part, and the electronic device 100 may include a magnetic force sensor (e.g., the first sensor 211 of FIG. 2) including a magnet (or magnetic material). When the electronic device 100 is coupled to the mounting part of the external electronic device, the Hall IC of the external electronic device may sense a magnet (e.g., the first sensor 211 of FIG. 2) disposed in the electronic device 100, and the external electronic device may transfer an electrical signal related to the coupling of the external electronic device and the electronic device 100 to the processor 120 through the connection terminal 160.

The connection terminal 160 may include, for example, a connector through which the electronic device 100 may be electrically connected to an external electronic device (e.g., a smailphone or the charging device). According to an embodiment, the connection terminal 160 may include, for example, a universal serial bus (USB) connector or a secure digital (SD) card connector.

According to various embodiments, the connection terminal 160 may include at least one contact (or terminal) (e.g., a first charging terminal 212 of FIG. 2) disposed on the outer surface of the housing. For example, when the electronic device 100 is mounted on the mounting part (not shown) of the external electronic device (e.g., a first socket 321 or a second socket 323 of FIG. 3), at least one contact (e.g., the first charging terminal 212 of FIG. 2) of the electronic device 100 may be electrically connected to at least one contact (e.g., a flexible terminal such as a pogo pin) (e.g., a third charging terminal 322 or fourth charging terminal 324 of FIG. 3) disposed on the mounting part of the external electronic device. The connection terminal 160 may receive power for charging the battery 180 from an external electronic device and transfer it to the charging circuit 140. The electronic device 100 may perform power line communication (PLC) with an external electronic device (e.g., a charging device of the electronic device 100) through the connection terminal 160.

The charging circuit 140 may manage power supplied to the electronic device 100, for example. According to an embodiment, the charging circuit 140 may be implemented as at least a part of a power management integrated circuit (PMIC).

The battery 180 may supply power to, for example, at least one component of the electronic device 100. According to an embodiment, the battery 180 may include a rechargeable secondary battery.

The communication circuit 110 may support establishment of a direct (e.g., wired) communication channel or wireless communication channel between the electronic device 100 and an external electronic device (e.g., a server, a smailphone, a personal computer (PC), a personal digital assistant (PDA), or an access point), and communication through the established communication channel According to various embodiments, the communication circuit 110 may include one or more communication processors that are operable independently from the processor 120 and support a direct (e.g., wired) communication or a wireless communication.

The communication circuit 110 may transmit or receive a signal or power to or from an external electronic device through at least one antenna (or antenna radiator) 191. The communication circuit 110 may include a wireless communication module (e.g., a short-range wireless communication module, or a global navigation satellite system (GNSS) communication module) or a wired communication module (e.g., a local area network (LAN) communication module or a power line communication (PLC) module). A corresponding communication module among the communication modules may communicate with an external electronic device through a first network (e.g., a short-range communication network such as Bluetooth, Bluetooth low energy (BLE), near field communication (NFC), Wi-Fi direct or infrared data association (IrDA)) or a second network (e.g., the Internet or a telecommunication network such as a computer network (e.g., a local area network (LAN) or wide area network (WAN)). These various types of communication modules may be integrated into a single component (e.g., a single chip), or may be implemented as multi components (e.g., multi chips) separate from each other. The electronic device 100 may include a plurality of antennas 111, and the communication circuit 110 may select at least one antenna suitable for a communication method used in a communication network from among the plurality of antennas 111. The signal or the power may be transmitted or received between the communication circuit 110 and the external electronic device through the selected at least one antenna.

All or some of the operations to be executed at the electronic device 100 may be executed by at least one external electronic device (e.g., a smartphone). For example, if the electronic device 100 should perform a function or a service automatically, or in response to a request from a user or another device, the electronic device 100, instead of, or in addition to, executing the function or the service by itself, may request at least one external electronic device to perform at least part of the function or the service. The at least external electronic device receiving the request may perform the at least part of the function or the service requested, or an additional function or an additional service related to the request, and transfer an outcome of the performing to the electronic device 100. The electronic device 100 may provide the outcome, with or without further processing of the outcome, as at least part of a reply to the request.

The command or data received by the processor 120 may be transmitted or received between the electronic device 100 and an external electronic device (e.g., a smailphone) through a server connected to the second network (e.g., the Internet, or a telecommunication network such as a computer network (e.g., LAN or WAN)).

The processor 120 may be configured to control various signal flows and control information collection and output regarding audio data. The processor 120 may be configured to receive audio data from an external electronic device (e.g., a server, a smailphone, a PC, a PDA, or an access point) through the communication circuit 110, and store the received audio data in the memory 130. The processor 120 may be configured to receive non-volatile audio data (or download audio data) from an external electronic device and store the received non-volatile audio data in a non-volatile memory. The processor 120 may be configured to receive volatile audio data (or streaming audio data) from an external electronic device and store the received volatile audio data in a volatile memory.

The processor 120 may be configured to play back audio data (e.g., non-volatile audio data or volatile audio data) stored in the memory 130 for output through the speaker 191. For example, the audio module 190 may generate an audio signal that may be output through the speaker 191 by decoding the audio data (e.g., audio data playback), and the generated audio signal may be output through the speaker 191.

The processor 120 may be configured to receive an audio signal from an external electronic device and output the received audio signal through the speaker 191. For example, an external electronic device (e.g., an audio playback device) may generate an audio signal by decoding audio data, and may transmit the generated audio signal to the electronic device 100.

A mode in which the electronic device 100 plays back volatile audio data or non-volatile audio data stored in the memory 130 and outputs it through the speaker 191 may be paused when a state in which the electronic device 100 is not coupled to the user's ear is confirmed through the sensor module 150. When the state in which the electronic device 100 is coupled to the user's ear is confirmed through the sensor module 150, the mode may be resumed.

A mode in which an audio signal is received from external electronic device and the received audio signal is output through the speaker 191 may be paused while the electronic device 100 is not coupled to the user's ear is confirmed through the sensor module 150. When the state in which the electronic device 100 is coupled to the user's ear is confirmed through the sensor module 150, the mode may be resumed.

When the electronic device 100 is communicatively connected to another electronic device set for ears (e.g., the second electronic device 220 of FIG. 2), the electronic device for one ear may be the master device and the electronic device for the other ear may be a slave device. For example, the electronic device 100, which is the master device, may not only output an audio signal received from an external electronic device (e.g., a smailphone) to the speaker 191, but also transmit the audio signal to the electronic device for the other ear (e.g., the second electronic device 220 in FIG. 2). The electronic device for the other ear may be implemented substantially the same as the electronic device 100, and may output the audio signal received from the electronic device 100 through the speaker.

The electronic device 100 may provide a voice recognition function for generating a voice command from an analog audio signal received through the microphone 192. The voice command may be utilized for various functions related to audio data.

The electronic device 100 may include a plurality of microphones (e.g., the microphone 192) capable of detecting the direction of sound. At least one of the plurality of microphones may be utilized for noise-cancelling.

The electronic device 100 may further include various modules according to its provision form. It is not possible to enumerate all of the variations due to the convergence trend of digital devices; however, components equivalent to the above-mentioned components may be additionally included in the electronic device 100. Further, in the electronic device 100 according to an embodiment of the disclosure, it is also possible to exclude specific components from the above components or replace some components with other components, according to the provision form thereof. This will be easily understood by those of ordinary skill in the art.

The communication circuit 110 may transmit or receive data through wireless communication with another electronic device. The communication circuit 110 may support wireless communication (e.g., Bluetooth, Bluetooth low energy, or Wi-Fi) that another electronic device is able to support, and the communication circuit 110 may perform various operations (e.g., advertisement signal output, paging signal output, wireless communication channel creation or wireless communication channel release) using the wireless communication supported thereby.

The memory 130 may store data received through the communication circuit 110 and/or the charging circuit 140 or information stored while the electronic device 100 is manufactured. The memory 130 may store information for a wireless communication connection between another electronic device and the electronic device 100. For example, the memory 130 may store address information about another electronic device.

The charging circuit 140 may perform an operation (e.g., control of the reception speed of power and control of the operation of transmitting the received power to the battery 180 of the electronic device 100) related to reception of power transmitted by the third electronic device through electrical connection between the electronic device 100 and the third electronic device (e.g., the third electronic device 300 of FIG. 3). The electronic device 100 may be electrically connected to the third electronic device in various ways. The electronic device 100 may be electrically connected to the third electronic device through the contact between a terminal of the electronic device 100 (e.g., the first charging terminal 212 of FIG. 2) and a terminal of the third electronic device (e.g., a third charging terminal 322 or a fourth charging terminal 324 of FIG. 3). As the terminal of the electronic device 100 and the terminal of the third electronic device are electrically connected, the charging circuit 140 may receive power from the third electronic device and a communication channel between the electronic device 100 and the third electronic device may be generated. The charging circuit 140 may exchange various data with the third electronic device through the communication channel generated between the electronic device 100 and the third electronic device. The charging circuit 140 may transmit data received from the third electronic device to the processor 120.

The communication channel between the electronic device 100 and the third electronic device may be a communication channel of various types that may be implemented by an electrical connection between the electronic device 100 and the third electronic device. The electrical connection between the electronic device 100 and the third electronic device may be made through the contact between the terminal of the electronic device 100 and the terminal of the third electronic device. According to an embodiment of the disclosure, the communication channel between the electronic device 100 and the third electronic device may be a communication channel implemented by power line communication (PLC). According to another embodiment of the disclosure, the electrical connection between the electronic device 100 and the third electronic device may be a connection by wireless communication (e.g., Bluetooth, BLE, or NFC) that is made without the contact between the electronic device 100 and the third electronic device through terminals.

The electronic device 100 and the third electronic device may transmit or receive, through the communication channel generated by the electrical connection between the electronic device 100 and the third electronic device, state information for the electronic device 100 (e.g., the charging state (remaining capacity state, charging voltage or temperature) of the electronic device 100 or information about another electronic device connected to the electronic device 100), state information for the second electronic device (e.g., charging state information for the second electronic device 220 of FIG. 2), or state information for the third electronic device (e.g., information about whether the third electronic device 300 of FIG. 3 is charged or temperature information for the third electronic device 300).

The processor 120 may be operatively connected to various electronic components (e.g., the communication circuit 110, the memory 130, and/or the charging circuit 140) included in the electronic device 100 and may control various components operatively connected to the processor 120.

The components (e.g., the communication circuit 110, the processor 120, the memory 130, and/or the charging circuit 140) shown in FIG. 1 and the embodiment have been described using the electronic device 100 (e.g., the first electronic device 210 of FIG. 2) as an example; however, the same may be applied to the second electronic device (e.g., the second electronic device 220 of FIG. 2).

Hereinafter, a configuration of an electronic device according to an embodiment will be described with reference to FIG. 2 and FIG. 3.

FIG. 2 is a diagram 200 schematically illustrating structures of Bluetooth electronic devices according to an embodiment of the disclosure. FIG. 3 is a diagram schematically illustrating a structure of a third electronic device according to an embodiment of the disclosure.

Referring to FIG. 2, the first electronic device 210 (e.g., the electronic device 100 of FIG. 1) and the second electronic device 220 may perform wireless communication in a short range according to a Bluetooth network defined by the Bluetooth SIG. The Bluetooth network may include, for example, a Bluetooth legacy network and a Bluetooth low energy (BLE) network. According to an embodiment, the first electronic device 210 and the second electronic device 220 may perform wireless communication through one of the Bluetooth legacy network and the BLE network, or may perform wireless communication through the two networks.

According to an embodiment of the disclosure, the first electronic device 210 and the second electronic device 220 may be accessory devices (e.g., earphones) constituting one set. For example, the first electronic device 210 and the second electronic device 200 may be devices that receive the same data (e.g., audio data) from one external electronic device (e.g., a smartphone). The first electronic device 210 and the second electronic device 220 may have the form of wireless earphones respectively inserted into both ears of the user. The first electronic device 210 and the second electronic device 220 may be completely inserted into the user's ears in the form of a “bean”.

The first electronic device 210 may include a first sensor 211. The first sensor 211 may be disposed at a position where the first sensor 211 is brought into contact with the third sensor 311 of a cover 310 of the third electronic device 300 when the first electronic device 210 is inserted into the first socket 321 of the third electronic device 300, which will be described later with reference to FIG. 3, and the cover 310 is in a closed state. The first sensor 211 may interact with the third sensor 311 included in the cover 310 of the third electronic device 300 to identify whether or not the cover 310 of the third electronic device 300 is in an open state.

The first sensor 211 may be a magnetic force sensor. The third sensor 311 may be a magnetic force sensor or a magnetic material. When the first sensor 211 of the first electronic device 210 is in contact with the third sensor 311 of the cover 310 with the first electronic device 210 inserted into the first socket 321 of the third electronic device 300 and the cover 310 of the third electronic device 300 closed, the magnetic force sensed by the first sensor 211 may be equal to or greater than a threshold value, and the first electronic device 210 may sense that the cover 310 of the third electronic device 300 is in the closes state. When the first electronic device 210 is inserted into the first socket 321 of the third electronic device 300 and the cover 310 of the third electronic device 300 is open, the magnetic force sensed by the first sensor 211 may be less than the threshold value, and the first electronic device 210 may sense that the cover 310 of the third electronic device 300 is in the open state.

The second electronic device 220 may include a second sensor 221. The second sensor 221 may be disposed at a position where the second sensor 221 is brought into contact with the fourth sensor 312 of the cover 310 of the third electronic device 300 when the second electronic device 220 is inserted into the second socket 323 of the third electronic device 300, which will be described later with reference to FIG. 3, and the cover 310 is in the closed state. The second sensor 231 may interact with the fourth sensor 312 included in the cover 310 of the third electronic device 300 to identify whether or not the cover 310 of the third electronic device 300 is in an open state.

The second sensor 221 may be a magnetic force sensor. The fourth sensor 312 may be a magnetic force sensor or a magnetic material. When the second sensor 221 of the second electronic device 220 is in contact with the fourth sensor 312 of the cover 310 with the second electronic device 220 inserted into the second socket 323 of the third electronic device 300 and the cover 310 of the third electronic device 300 closed, the magnetic force sensed by the second sensor 221 may be equal to or greater than a threshold value, and the second electronic device 220 may sense that the cover 310 of the third electronic device 300 is in the closes state. When the second electronic device 220 is inserted into the second socket 323 of the third electronic device 300 and the cover 310 of the third electronic device 300 is open, the magnetic force sensed by the second sensor 221 may be less than the threshold value, and the second electronic device 220 may sense that the cover 310 of the third electronic device 300 is in the open state.

The first electronic device 210 may include the first charging terminal 212. The first charging terminal 212 may be connected to the third charging terminal 322 of the third electronic device 300, which will be described later with reference to FIG. 3, to receive power from the third electronic device 300. The first electronic device 210 may be used to charge the battery (e.g., the battery 180 of FIG. 1) of the first electronic device 210 through the received power. When the first charging terminal 212 is electrically connected to the third charging terminal 322 of the third electronic device 300, the first electronic device 210 may sense that the first electronic device 210 is in the charging state. The first electronic device 210 may receive, from the third electronic device 300, information on whether the cover of the third electronic device 300 is in the open state.

The second electronic device 220 may include a second charging terminal 222. The second charging terminal 222 may be connected to the fourth charging terminal 324 of the third electronic device 300, which will be described later with reference to FIG. 3, to receive power from the third electronic device 300. The second electronic device 220 may be used to charge the battery of the second electronic device 220 through the received power. When the second charging terminal 222 is electrically connected to the fourth charging terminal 324 of the third electronic device 300, the second electronic device 220 may sense that the second electronic device 220 is in the charging state.

Each of the first electronic device 210 and the second electronic device 220 may recognize a counterpart device (e.g., the second electronic device 220 or the first electronic device 210) in advance, or store information about the counterpart device (e.g., address information) in advance.

When the first electronic device 210 identifies that the cover 310 of the third electronic device 300 is in the open state, the first electronic device 210 may establish a first communication link with the second electronic device 220.

In order to establish the first communication link with the second electronic device 220, the first electronic device 210, which is an electronic device that will serve as a master, may perform a BLE scan. The second electronic device 220, which is an electronic device that will serve as a slave, may perform BLE advertising. Alternatively, when the first electronic device 210 and the second electronic device 220 operate a communication link using Bluetooth legacy instead of Bluetooth low energy (BLE), the first electronic device 210 may perform paging, and the second electronic device 220 may perform a page scan. Alternatively, according to an embodiment, the second electronic device 220 may serve as the master and the first electronic device 210 may serve as the slave. According to an embodiment of the disclosure, the device serving as the master and the device serving as the slave may be changed. For example, a device serving as the master may be determined based on the remaining battery level.

The first electronic device 210 may receive information on whether the second electronic device 220 is in the charging state from the second electronic device 220 through the first communication link.

Referring to FIG. 3, the third electronic device 300 may include a body 320 and the cover 310. In the third electronic device 300, the body 320 and the cover 310 may be connected to each other so that the cover 310 covers one surface of the body 320.

The body 320 of the third electronic device 300 may include the first socket 321 into which the first electronic device 210 may be inserted. The third charging terminal 322 may be positioned in the first socket 321. The third charging terminal 322 may be connected to the first charging terminal 212 of the first electronic device 210 to be used to charge the first electronic device 210.

The body 320 of the third electronic device 300 may include the second socket 323 into which the second electronic device 220 may be inserted. The fourth charging terminal 324 may be positioned in the second socket 323. The fourth charging terminal 324 may be connected to the second charging terminal 222 of the second electronic device 220 to be used to charge the second electronic device 220. The cover 310 of the third electronic device 300 may include the third sensor 311. The third sensor 311 may be disposed at a position corresponding to the first socket 321 positioned on the body 320 so that the first electronic device 210 may be inserted, in the surface of the cover 310 covering one surface of the body 320. The third sensor 311 may sense the first sensor 211 of the first electronic device 210 or the second sensor 221 of the second electronic device 220 to be used to identify whether the cover 310 of the third electronic device 300 is in the open state. The third sensor 311 may interact with the first sensor 211 of the first electronic device 210 in the state in which the first electronic device 210 is inserted into the first socket 321. The third sensor 311 may be a magnetic force sensor or a magnetic material. When the cover 310 is closed in the state in which the first electronic device 210 is inserted into the first socket 321 and the first sensor 211 of the first electronic device 210 and the third sensor 311 of the cover 310 are close to each other, the magnetic force sensed by the first sensor 211 may be equal to or greater than a threshold value. When the magnetic force sensed by the first sensor 211 is equal to or greater than the threshold value, the first electronic device 210 may sense that the cover 310 of the third electronic device 300 is in the closed state.

The cover 310 of the third electronic device 300 may include the fourth sensor 312. The fourth sensor 312 may be disposed at a position corresponding to the second socket 323 positioned on the body 320 so that the second electronic device 220 may be inserted, in the surface of the cover 310 covering one surface of the body 320. The fourth sensor 312 may be used to identify whether the cover 310 of the third electronic device 300 is in the open state. The fourth sensor 312 may interact with the second sensor 221 of the second electronic device 220 in the state in which the second electronic device 220 is inserted into the second socket 323. According to an embodiment of the disclosure, the fourth sensor 312 may be a magnetic force sensor or a magnetic material. When the cover 310 is closed in the state in which the second electronic device 230 is inserted into the second socket 323 and the third sensor 231 of the second electronic device 220 and the fourth sensor 312 of the cover 310 are close to each other, the magnetic force sensed by the second sensor 221 may be equal to or greater than a threshold value. The second electronic device 220 may be electrically connected to the fourth charging terminal 324 through the second charging terminal 222, and when the magnetic force sensed by the second sensor 221 is equal to or greater than a threshold value, may sense that the cover 310 of the third electronic device 300 is in the closed state. The first electronic device 210 or the second electronic device 220 may receive, from the third electronic device 300, information on whether the cover of the third electronic device 300 is in the open state.

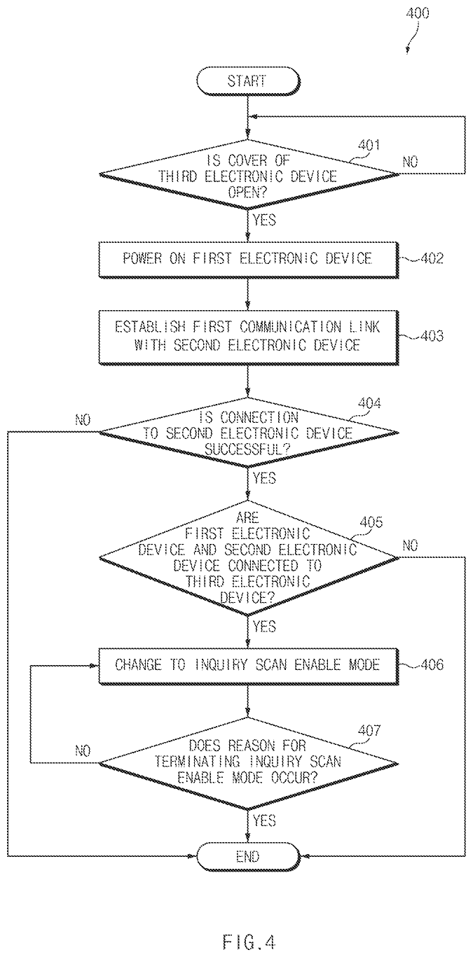

Hereinafter, an operation of an electronic device according to an embodiment will be described with reference to FIG. 4. A description of the same configuration as in the above-described embodiments may be omitted.

FIG. 4 is a flowchart 400 illustrating an operation of the first electronic device according to an embodiment of the disclosure.

Hereinafter, a description will be given assuming that the first electronic device serves as the master and the second electronic device serves as the slave.

Referring to FIG. 4, in operation 401, the first electronic device (e.g., the first electronic device 210 of FIG. 2) may determine whether the cover (the cover 310 of FIG. 3) of the third electronic device (e.g., the third electronic device 300 of FIG. 3) is open. Alternatively, the first electronic device may determine whether the cover of the third electronic device that has been closed is open. A method for the first electronic device to determine whether the cover of the third electronic device is open may be the same as the method in the embodiments described with reference to FIGS. 2 and 3. According to an embodiment of the disclosure, the method of determining whether the cover of the third electronic device that has been closed is open may determine that the cover of the third electronic device that has been closed is open when the first electronic device or the second electronic device senses a change in magnetic force through the first sensor or the second sensor.

In operation 402, when it is determined that the cover of the third electronic device is open, the first electronic device may power on the first electronic device. At this time, when it is determined that the cover of the third electronic device is open, the second electronic device may also power on the second electronic device. Alternatively, when it is determined that the cover of the third electronic device is open, the first electronic device may change its mode from a sleep mode to a wakeup mode.

In operation 403, the first electronic device may establish a first communication link with the second electronic device. The method of establishing the first communication link may be the same as the method in the embodiment described above with reference to FIG. 2. After establishing the first communication link, the first electronic device 210 and the second electronic device 220 may enable a page scan in order to receive a connection request of other electronic devices. When the first electronic device 210 and the second electronic device 220 have a history of creating a communication link with a first external electronic device (e.g., a smailphone) that is another external Bluetooth electronic device, the first electronic device 210 may make a connection request to the first external electronic device after establishing the first communication link. After establishing the first communication link, the first electronic device may establish a second communication link with the first external electronic device having the history of previously creating the communication link with the first electronic device.

In operation 404, the first electronic device may determine whether the first communication link connection with the second electronic device is successful. When the first electronic device and the second electronic device are successfully connected to the first communication link, the first electronic device 210 and the second electronic device 220 may exchange, with each other, information on the charging state and information on a battery level whenever the battery level is changed, through the first communication link.

In operation 405, the first electronic device may determine whether the first electronic device and the second electronic device are connected to the third electronic device if it is determined that the first communication link with the second electronic device is successful.

According to an embodiment of the disclosure, the reference to connecting the first electronic device and the third electronic device to each other may mean that the first electronic device is inserted into the socket of the third electronic device (e.g., the first socket 321 of FIG. 3). According to another embodiment of the disclosure, the reference to connecting the first electronic device and the third electronic device to each other may mean that the charging terminal of the first electronic device (e.g., the first charging terminal 212 of FIG. 2) is electrically connected to the charging terminal of the third electronic device (e.g., the third charging terminal 322 of FIG. 3). The method of determining whether the first electronic device and the third electronic device are connected to each other may be the same as the method in the embodiments described with reference to FIGS. 2 and 3.

The first electronic device may receive information on whether the second electronic device is connected to the third electronic device from the second electronic device through the first communication link. According to an embodiment of the disclosure, the reference to connecting the second electronic device and the third electronic device to each other may mean that the second electronic device is inserted into the socket of the third electronic device (e.g., the second socket 323 of FIG. 3). According to another embodiment of the disclosure, the reference to connecting the second electronic device and the third electronic device to each other may mean that the charging terminal of the second electronic device (e.g., the second charging terminal 222 of FIG. 2) is electrically connected to the charging terminal of the third electronic device (e.g., the fourth charging terminal 324 of FIG. 3). The method of determining whether the second electronic device and the third electronic device are connected to each other may be the same as the method in the embodiments described with reference to FIGS. 2 and 3. The second electronic device may determine whether it is connected to the third electronic device and transfer information thereon to the first electronic device through the first communication link.

In operation 406, the first electronic device may change the first electronic device from an inquiry scan disable mode to an inquiry scan enable mode if it is determined that both the first electronic device and the second electronic device are connected to the third electronic device. The first electronic device may determine that it is necessary to entry a pairing mode by identifying that the cover of the third electronic device is in the open state and identifying that the first electronic device is in a power-on state, the first communication link with the second electronic device is in an established state, and both the first electronic device and the second electronic device are in the charging state. If it is determined that it is necessary to enter the pairing mode, the first electronic device may switch to the inquiry scan enable mode in order to receive a search request of a nearby electronic device.

The Bluetooth electronic device (e.g., a smartphone) may identify a nearby device through an inquiry operation. In general, the Bluetooth electronic device performing an inquiry may continuously transmit an ID packet generated based on a general inquiry access code (GIAC) during a predetermined inquiry period, and the inquiry process may be performed by receiving the ID packet and transmitting a frequency hop synchronization (FHS) packet in response thereto by the electronic device (e.g., the first electronic device) performing the inquiry scan. The FHS packet may include at least one of a Bluetooth address of the electronic device performing the inquiry scan, a class of device (COD) indicating the type of the inquiry scan electronic device, an extended inquiry response (EIR) bit indicating whether there is a next packet, and clock information for the electronic device (e.g., the first electronic device) performing the inquiry scan.

According to an embodiment of the disclosure, an EIR packet is a main packet for transferring various pieces of information at the time of the inquiry, and may include important information to be used for connection and service such as a device name of the electronic device (e.g., the first electronic device) performing the inquiry scan for transferring the EIR packet, a transmit power level (Tx power level), a service class universal unique identifier (UUID), and manufacture's data. The Bluetooth electronic device (e.g., a smartphone) performing an inquiry may be able to provide various services based on various information acquired at the time of the inquiry through the EIR packet.

The Bluetooth electronic device (e.g., a smartphone) performing the inquiry may receive the FHS packet and the EIR packet, and provide the user with the Bluetooth address, name, and device type, or the like, of the discovered electronic device (e.g., the first electronic device) performing the inquiry scan through a user interface (UX) to induce connection of the user. For example, if the user searches for connectable electronic devices in the Bluetooth settings of the electronic device (e.g., a smartphone) of the user, the electronic device (e.g., a smartphone) of the user may provide the discovered connectable electronic devices to the user through the UX based on a certain criterion. The electronic device (e.g., a smartphone) of the user may preferentially display an electronic device having a strong signal strength among connectable electronic devices, or may display the names of the connectable electronic devices in alphabetical order. In addition, the discovered connectable electronic devices may be displayed based on various criteria.

According to an embodiment of the disclosure, the first electronic device may correspond to an inquiry scan electronic device capable of making its existence known in response to a search request of an external inquiry electronic device performing a search. If the inquiry scan electronic device responds to all search requests of external devices, the Bluetooth address of the inquiry scan electronic device may be exposed to the outside and the user may receive an unintentional connection request, and accordingly, the inquiry scan electronic device may switch to the inquiry scan enable mode only if a specific condition is satisfied. The first electronic device may switch to the inquiry scan enable mode by identifying that the cover of the third electronic device is in the open state and the first electronic device and the second electronic device are connected to the third electronic device.

The first electronic device switched to the inquiry scan enable mode may perform the inquiry scan using low power and/or a low received signal strength indicator (RSSI). For example, if the first electronic device responds (e.g., transmits the FHS packet) to a search request (e.g., reception of an ID packet) of an external Bluetooth electronic device located at a far distance in the inquiry scan enable mode, the first electronic device may receive a connection request from the external Bluetooth electronic device located at the far distance contrary to the user's intention. Accordingly, the first electronic device may respond only to a search request of the external Bluetooth electronic device having a specific signal strength or higher. According to an embodiment of the disclosure, the first electronic device may respond only to a search request of a specified signal strength (e.g., −45 dBm or more) of the external Bluetooth electronic device.

According to another embodiment of the disclosure, the first electronic device responds to all received search requests, but may respond with a specific transmit power (Tx power). The first electronic device may transmit a response signal with a specified signal strength (e.g., −10 dBm or less). In this case, the external Bluetooth electronic device located at a distance far away from the first electronic device may not receive the response signal of the first electronic device, and thus it is possible to prevent the first electronic device from receiving a connection request of the external Bluetooth electronic device located at a far distance contrary to the user's intention.

The second external electronic device that has received the response signal transmitted by the first electronic device switched to the inquiry scan enable mode may receive the FHS packet and the EIR packet, and provide the Bluetooth address, name, or device type of the first electronic device to the user of the inquiry electronic device. When the user of the second external electronic device selects the discovered first electronic device, the first electronic device and the second external electronic device may establish a third communication link. In this case, when the first electronic device is connected to the first external electronic device by the second communication link, the first electronic device may release the second communication link and establish the third communication link with the second external electronic device. Alternatively, when the first electronic device is an electronic device providing a multi-point connection, the first electronic device may establish the third communication link with the second external electronic device while maintaining the second communication link.

In operation 407, the first electronic device may determine whether a reason for terminating the inquiry scan enable mode occurs. The first electronic device may switch the inquiry scan enable mode to the inquiry scan disable mode as the reason for terminating the inquiry scan enable mode occurs.

Then the first communication link is released, the first electronic device may switch to the inquiry scan disable mode. The first electronic device may switch to the inquiry scan disable mode when at least one of the first electronic device and the second electronic device is disconnected from the third electronic device. The first electronic device may switch to the inquiry scan disable mode when it is identified that the cover of the third electronic device is in the closed state. According to an embodiment of the disclosure, the first electronic device may switch to the inquiry scan disable mode at the end of a timer set when entering the inquiry scan enable mode.

According to another embodiment of the disclosure, the first electronic device may switch to the inquiry scan disable mode when the battery of at least one of the first electronic device and the second electronic device is exhausted and the power is turned off According to another embodiment of the disclosure, the first electronic device may switch to the inquiry scan disable mode when at least one of the first electronic device and the second electronic device is located at a distance where Bluetooth communication is not able to be maintained.

According to an embodiment of the disclosure, the first electronic device may maintain the inquiry scan enable mode as long as the reason for terminating the inquiry scan enable mode does not occur.

According to an embodiment of the disclosure, if the user wants to connect the first electronic device to the second external electronic device (e.g., a tablet PC) having no history of connecting to the first electronic device while the user is using the first electronic device by connecting it to the first external electronic device (e.g., a smartphone), the user may connect the second external electronic device and the first electronic device to each other by selecting the discovered first electronic device in the Bluetooth settings of the second external electronic device at a location close to the first electronic device in the state in which the cover of the third electronic device is in the open state after inserting the first electronic device and the second electronic device into the sockets of the third electronic device.

The flowchart of FIG. 4 is only exemplary, and according to an embodiment, an operation of FIG. 4 may be omitted, the order between operations may be changed, or operations may be merged.

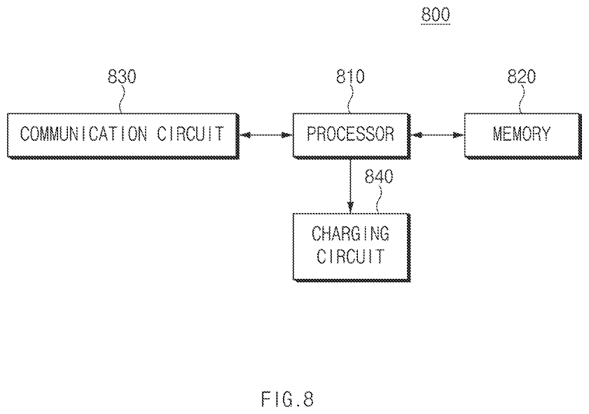

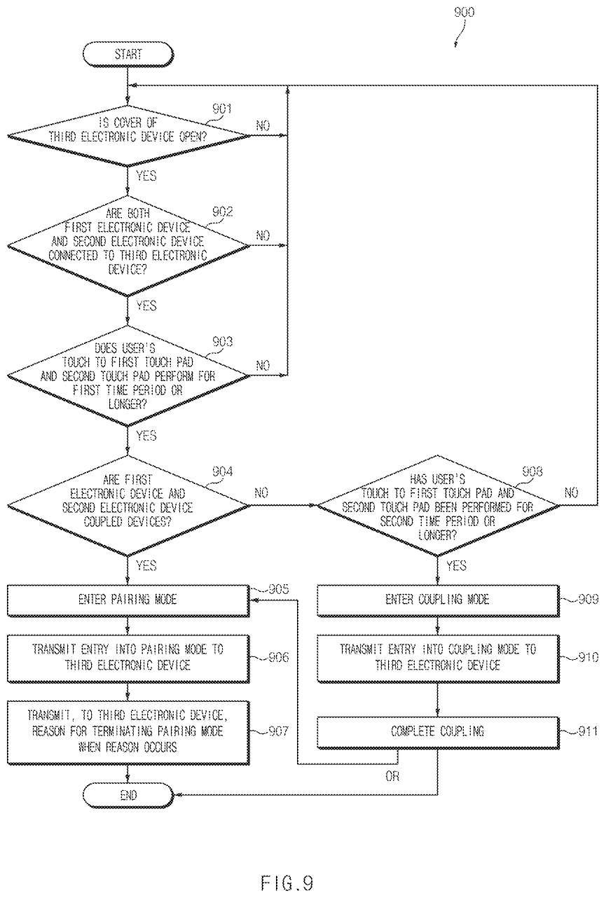

In addition, according to an embodiment of the disclosure, the first electronic device may further check external inputs of the first electronic device and the second electronic device when checking the switching condition of the inquiry scan enable mode. According to an embodiment of the disclosure, the first electronic device and the second electronic device may further include a touch pad to receive a user input. While the cover of the third electronic device is open, if both the first electronic device and the second electronic device are mounted on the third electronic device and the user presses both the touch pads of the first electronic device and the second electronic device, the switching to the inquiry scan enable mode may be possible. The embodiment will be described in detail below with reference to FIGS. 8 to 9.

According to another embodiment of the disclosure, while the cover of the third electronic device is open, when both the first electronic device and the second electronic device are mounted on the third electronic device and the user presses a button included in the third electronic device for inputting, the first electronic device may receive a designated signal from the third electronic device through the first charging terminal (e.g., the first charging terminal 212 of FIG. 2) and switch to the inquiry scan enable mode.

According to another embodiment of the disclosure, if it is determined that the cover of the third electronic device is open and the first electronic device and the second electronic device are connected to the third electronic device, the first electronic device may determine whether a certain time elapses since the cover of the third electronic device gets open, and if it is determined that the certain time elapses since the cover of the third electronic device gets open, the first electronic device may enter the inquiry scan enable mode and perform the inquiry scan for a certain time.

According to another embodiment of the disclosure, as the user opens the cover of the third electronic device and inserts the first electronic device and the second electronic device into the third electronic device, the first electronic device may determine that the cover of the third electronic device is open and the first electronic device and the second electronic device are connected to the third electronic device, and accordingly, may enter the inquiry scan enable mode.

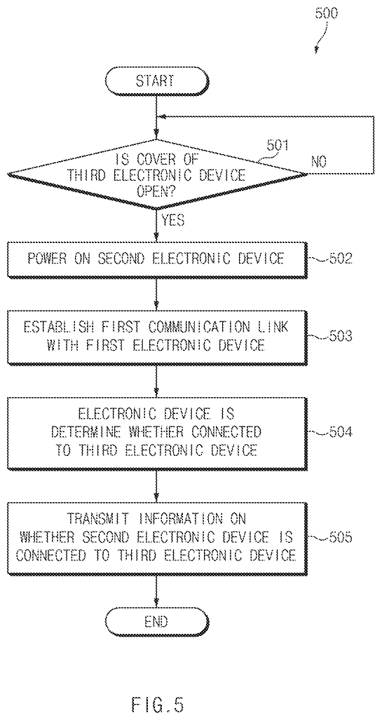

Hereinafter, an operation of an electronic device according to an embodiment will be described with reference to FIG. 5. A description of the same configuration as in the above-described embodiments may be omitted.

FIG. 5 is a flowchart 500 illustrating an operation of a second electronic device (e.g., the second electronic device 220 of FIG. 2) according to an embodiment of the disclosure.

Hereinafter, a description will be given assuming that the first electronic device (e.g., the first electronic device 210 of FIG. 2) serves as the master and the second electronic device serves as the slave.

Referring to FIG. 5, in operation 501, the second electronic device (e.g., the second electronic device 220 of FIG. 2) may determine whether the cover (the cover 310 of FIG. 3) of the third electronic device (e.g., the third electronic device 300 of FIG. 3) is open. Alternatively, the second electronic device may determine whether the cover of the third electronic device that has been closed is open. A method for determining, by the second electronic device, whether the cover of the third electronic device is open may be the same as the method in the embodiments described with reference to FIGS. 2 and 3. The method of determining whether the cover of the third electronic device that has been closed is open may determine that the cover of the third electronic device that has been closed gets open when the first electronic device or the second electronic device senses a change in magnetic force through the first sensor or the second sensor.

In operation 502, when it is determined that the cover of the third electronic device is open, the second electronic device may power on the second electronic device. Alternatively, when it is determined that the cover of the third electronic device is open, the second electronic device may change its mode from a sleep mode to a wakeup mode.

In operation 503, the second electronic device may establish the first communication link with the first electronic device. The method of establishing the first communication link may be the same as the method in the embodiment described above with reference to FIG. 2.

In operation 504, the second electronic device may determine whether the second electronic device and the third electronic device are connected to each other if it is determined that the first communication link with the first electronic device is successful. According to an embodiment of the disclosure, the reference to connecting the second electronic device and the third electronic device to each other may mean that the second electronic device is inserted into the socket of the third electronic device (e.g., the second socket 323 of FIG. 3). According to another embodiment of the disclosure, the reference to connecting the second electronic device and the third electronic device to each other may mean that the charging terminal of the second electronic device (e.g., the second charging terminal 222 of FIG. 2) is connected to the charging terminal of the third electronic device (e.g., the fourth charging terminal 324 of FIG. 3). The method of determining whether the second electronic device and the third electronic device are connected to each other may be the same as the method in the embodiments described with reference to FIGS. 2 and 3.

In operation 505, the second electronic device may transmit information on whether the second electronic device is connected to the third electronic device, to the first electronic device through the first communication link. The second electronic device may determine whether it is connected to the third electronic device and transfer information thereon to the first electronic device through the first communication link.

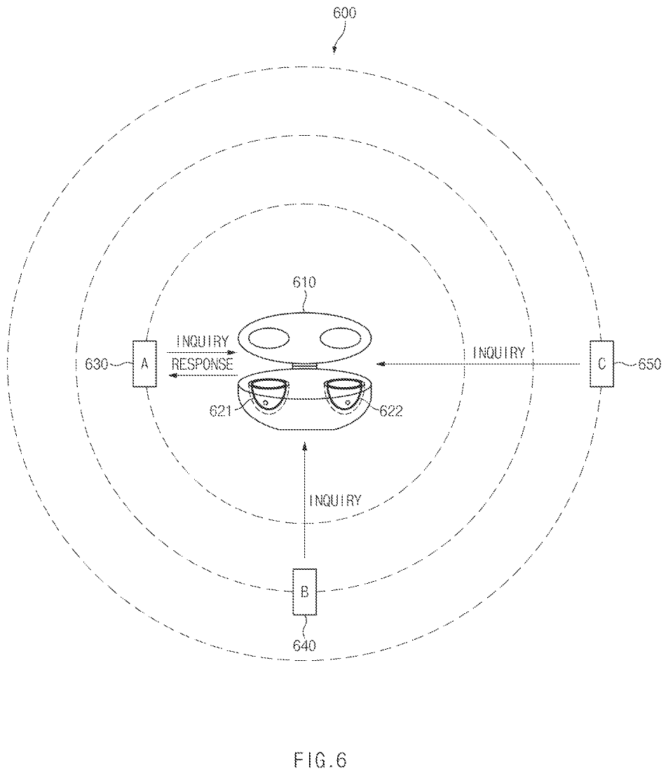

Hereinafter, an operation of an electronic device according to an embodiment will be described with reference to FIG. 6. A description of the same configuration as in the above-described embodiments may be omitted.

FIG. 6 is a diagram 600 for describing an operation of a first electronic device (e.g., the first electronic device 210 of FIG. 2) according to an embodiment of the disclosure.

Hereinafter, a description will be given assuming that the first electronic device serves as the master and a second electronic device (e.g., the second electronic device 220 of FIG. 2) serves as the slave.

Referring to FIG. 6, a first electronic device 621 may determine whether a cover of a third electronic device 610 is open. Alternatively, the first electronic device 621 may determine whether the cover of the third electronic device 610 that has been closed gets open. A method for determining, by the first electronic device 621, whether the cover of the third electronic device 610 is open may be the same as the method in the embodiments described with reference to FIGS. 2 and 3. According to an embodiment of the disclosure, the method of determining whether the cover of the third electronic device 610 that has been closed is open may determine that the cover of the third electronic device 610 that has been closed gets open when the first electronic device 621 or a second electronic device 622 senses a change in magnetic force through the first sensor or the second sensor. Further, the first electronic device 621 may determine whether the first electronic device 621 and the second electronic device 622 are connected to the third electronic device 610. The method of determining whether the first electronic device 621 and the second electronic device 622 are connected to the third electronic device 610 may be the same as the method in the embodiments described with reference to FIGS. 2 and 3.

The first electronic device 621 may change the first electronic device 621 from an inquiry scan disable mode to an inquiry scan enable mode if it is determined that the cover of the third electronic device 610 is open and both the first electronic device 621 and the second electronic device 622 are connected to the third electronic device 610.

A first external electronic device 630, a second external electronic device 640, and a third external electronic device 650 may be located around the first electronic device 621 in the order of increasing distance. The first external electronic device 630, the second external electronic device 640, and the third external electronic device 650 may continuously transmit, to an inquiry electronic device during a predetermined inquiry period, an ID packet generated based on a general inquiry access code (GIAC).

The first electronic device 621 switched to the inquiry scan enable mode may perform the inquiry scan using a low received signal strength indicator (RSSI). According to an embodiment of the disclosure, the first electronic device 621 may respond only to a search request of the external Bluetooth electronic device having a specific threshold value or higher. According to an embodiment of the disclosure, the first electronic device 621 may transmit a response only to the inquiry of the first external electronic device 630 having the signal strength of the threshold value or higher among the inquiries of the first external electronic device 630, the second external electronic device 640, and the third external electronic device 650. In this way, it is possible to prevent the first electronic device 621 from receiving a connection request of an external Bluetooth electronic device located at a far distance contrary to the user's intention.

According to another embodiment of the disclosure, the first electronic device 621 may respond only to a search request of a specific threshold value or higher of the external Bluetooth electronic device, and if the search request of the specific threshold value or higher is not searched for, the first electronic device 621 may adjust the threshold value to a lower value to respond to the search request of the adjusted threshold value or higher.

Alternatively, although not shown in FIG. 6, according to an embodiment of the disclosure, the first electronic device 621 may respond to all inquiries of the first external electronic device 630, the second external electronic device 640, and the third external electronic device 650, with the transmit power (Tx power) of a specific threshold value or lower. In this case, the second external electronic device 640 and the third external electronic device 650 located far away from the first electronic device 621 may not receive the response signal of the first electronic device 621. Accordingly, it is possible to prevent the first electronic device 621 from receiving a connection request of an external Bluetooth electronic device located at a far distance contrary to the user's intention.

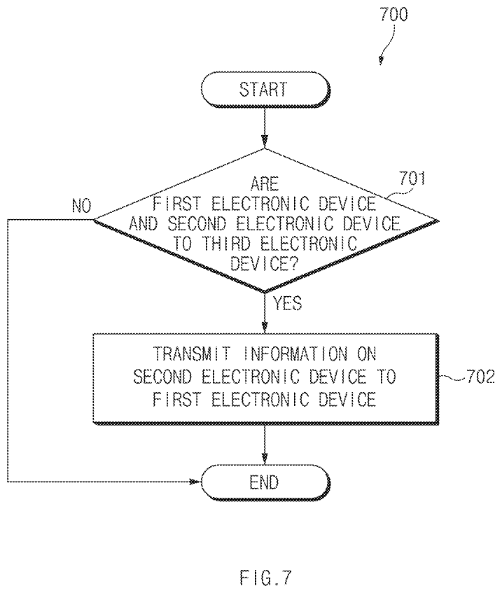

Hereinafter, an operation of an electronic device according to an embodiment will be described with reference to FIG. 7. A description of the same configuration as in the above-described embodiments may be omitted.

FIG. 7 is a flowchart 700 illustrating an operation of a third electronic device (e.g., the third electronic device 300 of FIG. 3) according to an embodiment of the disclosure.

Hereinafter, a description will be given assuming that a first electronic device (e.g., the first electronic device 210 of FIG. 2) serves as the master and a second electronic device (e.g., the second electronic device 220 of FIG. 2) serves as the slave.

Referring to FIG. 7, in operation 701, the third electronic device (e.g., the third electronic device 300 of FIG. 3) may determine whether the first electronic device (e.g., the first electronic device 210 of FIG. 2) and the second electronic device (e.g., the second electronic device 220 of FIG. 2) are connected to the third electronic device.

When the first electronic device and the second electronic device are mounted on the sockets of the third electronic device (e.g., the first socket 321 and/or the second socket 323 of FIG. 3), at least one charging terminal (e.g., the first charging terminal 212 of FIG. 2) of the first electronic device may be electrically connected to at least one charging terminal (e.g., a flexible terminal such as a pogo pin) (e.g., the third charging terminal 322 or fourth charging terminal 324 of FIG. 3) disposed on the sockets of the third electronic device. The first electronic device and/or the second electronic device may charge the battery through power received from the third electronic device through the charging terminal. The third electronic device may perform power line communication (PLC) communication with the first electronic device and/or the second electronic device through the charging terminal. The third electronic device may exchange various data with the first electronic device and/or the second electronic device through the communication channel generated between the first electronic device and/or the second electronic device. The communication channel between the first electronic device and/or the second electronic device and the third electronic device may be a communication channel implemented by power line communication (PLC).

In operation 702, if it is determined that the first electronic device and the second electronic device are connected to the third electronic device, the third electronic device may transmit information on the second electronic device to the first electronic device. The information on the second electronic device may include information on whether the second electronic device is connected to the third electronic device. In FIG. 5, it is determined whether the second electronic device is connected to the third electronic device and information thereon is transmitted to the first electronic device through the first communication link; however, this corresponds to an embodiment, and as shown in FIG. 7, the third electronic device may transmit information on the second electronic device to the first electronic device.

In addition, the third electronic device may transmit state information for the second electronic device (e.g., the state of charge of the second electronic device (remaining capacity state, state of charge voltage or temperature)) or state information for the third electronic device (e.g., whether the third electronic device is charging or temperature information) through the communication channel generated by the electrical connection between the first electronic device and the third electronic device.

An electronic device (210) according to an embodiment of the disclosure includes a wireless communication circuit (110) for Bluetooth communication, a sensor (211), a connection terminal (212) for connection with a first external electronic device (300), a processor (120) operatively connected to the sensor and the wireless communication circuit, and a memory (130) operatively connected to the processor, in which the memory may store instructions that, when executed, cause the processor to determine by means of the sensor whether a cover (310) of the first external electronic device is open; determine whether or not the connection terminal is electrically connected to the first external electronic device if it is determined that the cover of the first external electronic device is open, and, switch the wireless communication circuit to an inquiry scan enable mode if it is determined that the connection terminal is connected to the first external electronic device.

The instructions may cause the processor to receive information about whether or not a second external electronic device (220) connected to the electronic device through a first communication link using the wireless communication circuit of the electronic device is electrically connected to the first external electronic device, from the second external electronic device through the first communication link, and perform switching to the inquiry scan enable mode if it is further determined that the second external electronic device is connected to the first external electronic device.

The instructions may cause the processor to receive an inquiry signal from a third external electronic device (630, 640, or 650) after switching to the inquiry scan enable mode, and respond to the received inquiry signal if a strength of the inquiry signal is equal to or greater than a threshold value.

The instructions may cause the processor to receive an inquiry signal from a third external electronic device (630, 640, or 650) after switching to the inquiry scan enable mode, and respond to the received inquiry signal with a signal strength that is lower than or equal to a threshold value.

The sensor (211) may be a magnetic force sensor, and the instructions may cause the processor to determine whether or not the cover is open through the magnetic force sensor (311) included in the first external electronic device (300).

The instructions may cause the processor to power on the electronic device (210) if it is determined that the cover (310) of the first external electronic device (300) is in an open state.

The instructions may cause the processor to establish a first communication link with a second external electronic device (220) through the wireless communication circuit (110) after powering on the electronic device (210).

The instructions may cause the processor to charge a battery (180) of the electronic device with power received from the first external electronic device through the connection terminal (212) if the electronic device is electrically connected to the first external electronic device (300) through the connection terminal.

The instructions may cause the processor to respond to an inquiry received from a third external electronic device (630, 640, or 630), and establish a third communication link with the third external electronic device if a connection request is received from the third external electronic device.

An electronic device (220) according to an embodiment of the disclosure may include a wireless communication circuit (110) for Bluetooth communication, a sensor (221), a connection terminal (222) for connection with a first external electronic device, a processor (120) operatively connected to the sensor and the wireless communication circuit, and a memory (130) operatively connected to the processor, in which the memory stores instructions that, when executed, cause the processor to determine by means of the sensor (221) whether a cover (310) of the first external electronic device (300) is open, determine whether or not the connection terminal (222) is electrically connected to the first external electronic device (300) if it is determined that the cover of the first external electronic device is open, and transmit, by means of the wireless communication circuit (110), information about whether or not the electronic device and the first external electronic device are electrically connected to each other to the second external electronic device (210) connected to the electronic device through the first communication link, if it is determined that the connection terminal is in a state of being connected to the first external electronic device.

The instructions may cause the processor to power on the electronic device (220) if it is determined that the cover of the first external electronic device (300) is in an open state.

The instructions may cause the processor to establish the first communication link with the second external electronic device (210) through the wireless communication circuit after powering on the electronic device (220).

A method for operating an electronic device including a wireless communication circuit for Bluetooth communication, according to an embodiment of the disclosure includes determining by means of a sensor (211) of the electronic device (210) whether a cover (310) of a first external electronic device (300) is open, determining whether or not a connection terminal (212) of the electronic device is electrically connected to the first external electronic device if it is determined that the cover of the first external electronic device is open, and performing switching to an inquiry scan enable mode if it is determined that the connection terminal is connected to the first external electronic device.

The operating method may further include receiving, from a second external electronic device (220) connected to the electronic device through a first communication link, information about whether or not the second external electronic device is connected to the first external electronic device (300), and performing switching to the inquiry scan enable mode if it is further determined that the second external electronic device is connected to the first external electronic device.

The operating method may further include receiving an inquiry from a third external electronic device (630, 640, or 650) after switching to the inquiry scan enable mode, and responding to the received inquiry if a strength of a signal of the inquiry is equal to or greater than a threshold value.

The operating method may further include receiving an inquiry from a third external electronic device after switching to the inquiry scan enable mode, and responding to the received inquiry signal with a strength of a signal of the threshold value or lower.

In the operating method, the sensor (211) may be a magnetic force sensor, and may determine whether or not the cover is open through the magnetic force sensor (311) included in the first external electronic device (300).

The operating method may further include powering on the electronic device (210) if it is determined that the cover (310) of the first external electronic device (300) is in an open state.

The operating method may further include establishing a first communication link with a second external electronic device (220) after powering on the electronic device (210).

The operating method may further include charging a battery (180) of the electronic device with power of the first external electronic device (300) if the electronic device is electrically connected to the first external electronic device (300) through the connection terminal (212).

Hereinafter, an operation of an electronic device according to an embodiment of the disclosure will be described with reference to FIGS. 8 and 9. A description of the same configuration as in the above-described embodiments may be omitted.

FIG. 8 is a block diagram 800 illustrating a configuration of a third electronic device (e.g., the third electronic device 300 of FIG. 3) according to an embodiment of the disclosure.

FIG. 9 is a flowchart 900 illustrating an operation of a first electronic device (e.g., the first electronic device 210 of FIG. 2) according to an embodiment of the disclosure.

Referring to FIG. 8, a third electronic device (e.g., the third electronic device 300 of FIG. 3) may include a processor 810, a memory 820, a communication circuit 830, and a charging circuit 840.

The communication circuit 830 may transmit and receive data to and from one or more of the first electronic device (e.g., the first electronic device 210 of FIG. 2), a second electronic device (e.g., the second electronic device 220 of FIG. 2), and an external electronic device (e.g., a smailphone) through wireless communication.

The communication circuit 830 may support wireless communication (e.g., Bluetooth, Bluetooth low energy, or Wi-Fi) that the first electronic device 210, the second electronic device 220 or the external electronic device is able to support, and the communication circuit 830 may perform various operations (e.g., advertisement signal output, paging signal output, wireless communication channel creation or wireless communication channel release) using the wireless communication supported thereby. The communication circuit 830 may transmit, to the first electronic device 210 and/or the second electronic device 220, a signal for controlling the operation of the first electronic device 210 and/or the second electronic device 220 (e.g., a content output operation of the first electronic device 210 and/or the second electronic device 220).

The charging circuit 840 may perform an operation related to power transmission to the first electronic device 210 (e.g., transmission rate control for power) through the physical/electrical connection between the first electronic device 210 and the third electronic device 300. The third electronic device 300 may be physically/electrically connected to the first electronic device 210 in various ways.

The third electronic device 300 may have a space into which the first electronic device 210 and/or the second electronic device 220 may be inserted (e.g., the first socket 321 or the second socket 323 of FIG. 3). If the first electronic device 210 is inserted into the first socket 321 of the third electronic device 300, the charging terminal of the third electronic device 300 (e.g., the third charging terminal 322 of FIG. 3) and the charging terminal of the first electronic device 210 (e.g., the first charging terminal 212 of FIG. 2) may be electrically connected to each other. If the second electronic device 220 is inserted into the second socket 323 of the third electronic device 300, the charging terminal of the third electronic device 300 (e.g., the fourth charging terminal 324 of FIG. 3) and the charging terminal of the second electronic device 220 (e.g., the second charging terminal 222 of FIG. 2) may be electrically connected to each other.

If contact between the first charging terminal 212 of the first electronic device 210 and the third charging terminal 322 of the third electronic device 300 occurs, the electrical connection between the first electronic device 210 and the third electronic device 300 may be generated. The third electronic device 300 may transmit power to the first electronic device 210 through the electrical connection between the first electronic device 210 and the third electronic device 300, and the communication channel between the first electronic device 210 and the third electronic device 300 may be generated.

As a contact between the second charging terminal 222 of the second electronic device 220 and the fourth charging terminal 324 of the third electronic device 300 occurs, the electrical connection between the second electronic device 220 and the third electronic device 300 may be generated. The third electronic device 300 may transmit power to the second electronic device 220, and a communication channel between the second electronic device 220 and the third electronic device 300 may be generated.

The communication channel between the first electronic device 210 and the third electronic device 300 or the communication channel between the second electronic device 220 and the third electronic device 300 may be various types of communication channels that may be implemented depending on the electrical connection between the first electronic device 210 and the third electronic device 300 or between the second electronic device 220 and the third electronic device 300. According to an embodiment of the disclosure, the electrical connection between the first electronic device 210 and the third electronic device 300 may be generated by the electrical connection between the first charging terminal 212 of the first electronic device 210 and the third charging terminal 322 of the third electronic device 300. The communication channel between the first electronic device 210 and the third electronic device 300 may be a communication channel implemented by power line communication (PLC) generated between the charging circuit (e.g., the charging circuit 140 of FIG. 1) of the first electronic device 210 and the charging circuit 840 of the third electronic device 300. According to another embodiment of the disclosure, the electrical connection between the first electronic device 210 and the third electronic device 300 may be a connection by wireless communication (e.g., Bluetooth, BLE, or NFC) that is made without the contact between the first electronic device 210 and the third electronic device 300.

According to an embodiment of the disclosure, the electrical connection between the second electronic device 220 and the third electronic device 300 may be generated by the contact between the second charging terminal 222 of the second electronic device 220 and the fourth charging terminal 324 of the third electronic device 300. The communication channel between the second electronic device 220 and the third electronic device 300 may be a communication channel implemented by power line communication (PLC) generated between the charging circuit of the second electronic device 300 and the charging circuit 840 of the third electronic device 300. According to another embodiment of the disclosure, the electrical connection between the second electronic device 220 and the third electronic device 300 is a connection by wireless communication (e.g., Bluetooth, BLE, or NFC) that is made without the contact between the second electronic device 220 and the third electronic device 300.

Through the communication channel generated by the electrical connection between the first electronic device 210 and the third electronic device 300, the third electronic device 300 may receive state information for the first electronic device 210 (e.g., the charging state (e.g., remaining capacity state, charging voltage or temperature) of the first electronic device 210 or information about another electronic device connected to the first electronic device 210), or transmit state information for the second electronic device 220 (e.g., charging state information for the second electronic device 220), or state information for the third electronic device 300 (e.g., information about whether the third electronic device 300 is charged or temperature information for the third electronic device 300).

Through the communication channel generated by the electrical connection between the second electronic device 220 and the third electronic device 300, the third electronic device 300 may receive state information for the second electronic device 220 (e.g., the charging state (e.g., remaining capacity state, charging voltage or temperature) of the second electronic device 220 or information about another electronic device connected to the second electronic device 220), or transmit state information for the first electronic device 210 (e.g., charging state information for the first electronic device 210), or state information for the third electronic device 300 (e.g., information about whether the third electronic device 300 is charged or temperature information for the third electronic device 300).

The memory 820 may store data received through the communication circuit 830 of the third electronic device and/or the charging circuit 140 or information (e.g., identification information for the third electronic device 300) stored while the third electronic device 300 is manufactured. The memory 820 may store information for a wireless communication connection between the first electronic device 210, the second electronic device 220, and/or the external electronic device and the third electronic device 300. For example, the memory 820 may store address information for the first electronic device 210, address information for the second electronic device 220, or address information for the external electronic device.

The processor 810 may be operatively connected to various electronic components (e.g., the memory 820) included in the third electronic device 300 and may control various components operatively connected to the processor 810.

The processor 810 may receive, from the first electronic device 210, information about the first electronic device 210 through a communication channel generated by the electrical connection between the first electronic device 210 and the third electronic device 300. The charging circuit 840 may receive the information about the first electronic device 210 from the first electronic device 210 through the communication channel generated by the electrical connection between the first electronic device 210 and the third electronic device 300, and may transmit the information about the first electronic device 210 to the processor 810.

The information about the first electronic device 210 may be address information for the first electronic device 210 which is required to be connected through the wireless communication between the first electronic device 210 and the second electronic device 220. For example, the address information for the first electronic device 210 may include at least one of an IP address of the first electronic device 210, an MAC address of the first electronic device 210, and a Bluetooth address of the first electronic device 210.

The processor 810 may receive information about the second electronic device 220 through a communication channel generated by the electrical connection between the second electronic device 220 and the third electronic device 300.

The information about the second electronic device 220 may be address information for the second electronic device 220 which is required to be connected through the wireless communication between the first electronic device 210 and the second electronic device 220. For example, the address information for the second electronic device 220 may include at least one of an IP address of the second electronic device 220, an MAC address of the second electronic device 220, and a Bluetooth address of the second electronic device 220.

The processor 810 may transmit the information about the second electronic device 220 received from the second electronic device 220 to the first electronic device 210. The processor 810 may transmit the information about the first electronic device 210 received from the first electronic device 210 to the second electronic device 220.

An operation of transmitting data (e.g., address information for the second electronic device 220) from the third electronic device 300 to the first electronic device 210 and an operation of transmitting data (e.g., address information for the first electronic device 210) to the second electronic device 220 may use a bi-phase mark code method. For example, in transmitting the information about the second electronic device 220 to the first electronic device 210, the processor 810 may control the charging circuit 840 to perform transmission in a method of controlling the voltage of a signal including the information about the second electronic device 220. In another example, in receiving the information about the first electronic device 210 from the first electronic device 210, the processor 810 may control the charging circuit 840 to receive the information about the first electronic device 210 in a method of controlling a current of a signal including the information about the first electronic device 210. The above methods may prevent signals exchanged between the first electronic device 210 and the third electronic device 300 from interfering with each other.

A message including the information about the first electronic device 300 and the information about the second electronic device 220 exchanged through the third electronic device 300 may include a preamble indicating the start of data transmission, a header of data, and data. The header of data may include a type of the header, a parity bit for verifying whether the header is in error, and a start bit for indicating the start of data. The data may include a data message including the information about the first electronic device 210 or the information about the second electronic device 220, a parity bit for verifying whether data is in error, a checksum for verifying data integrity, and a stop bit for indicating the end of data.

After receiving the information about the first electronic device 210, the processor 810 may transmit, to the first electronic device 210, a message indicating that the information about the first electronic device 210 has been received.

The processor 810 may control the data communication between the first electronic device 210 and the third electronic device 300 through the communication channel generated by the electric connection between the first electronic device 210 and the third electronic device 300, and may control the data communication between the second electronic device 220 and the third electronic device 300 through the communication channel generated by the electric connection between the second electronic device 220 and the third electronic device 300.

The charging circuit 840 may control the data communication between the first electronic device 210 and the third electronic device 300 through the communication channel generated by the electric connection between the first electronic device 210 and the third electronic device 300, and may control the data communication between the second electronic device 220 and the third electronic device 300 through the communication channel generated by the electric connection between the second electronic device 220 and the third electronic device 300.

The third electronic device 300 may further include a user interface device (e.g., an LED device (not shown)) capable of outputting an indicator indicating an operating state of the third electronic device 300. The processor 810 may control the user interface to output an indicator indicating a state in which power is supplied (or charged) to the first electronic device 210 and/or the second electronic device 220. The processor 810 may control the user interface to output an indicator indicating a state in which the first electronic device 210 and/or the second electronic device 220 exchanges data (e.g., the information about the first electronic device 210 or the information about the second electronic device 220) with each other. The third electronic device 300 may control the user interface to output an indicator indicating a state in which the first electronic device 210 and/or the second electronic device 220 exchanges data (e.g., the information about the first electronic device 210 or the information about the second electronic device 220) with each other or a state in which information on the electronic device to be paired is updated, in response to receiving a user input requesting to update the information on an electronic device to be paired in the state in which the first electronic device 210 and/or the second electronic device 220 outputs an indicator indicating that charging is in progress.

The user interface device capable of outputting the indicator indicating the operating state of the third electronic device 300 may be implemented in various forms. For example, the user interface device may be implemented as an LED device (not shown) capable of outputting a visual indicator. In another example, the user interface device may be implemented as a speaker capable of outputting an audible indicator (e.g., a sound indicating a state in which the first electronic device 210 and/or the second electronic device 220 updates information on the electronic device to be paired, a sound indicating the remaining battery capacity of the third electronic device 300, a sound indicating the remaining battery capacity of the first electronic device 210 and/or the second electronic device 220, and/or a sound indicating the operating state of the first electronic device 210 and/or the second electronic device 220). In another example, the user interface device may be implemented as a haptic module capable of outputting a tactile indicator.

Referring to FIG. 9, in operation 901, the first electronic device (e.g., the first electronic device 210 of FIG. 2) may determine whether the cover (the cover 310 of FIG. 3) of the third electronic device (e.g., the third electronic device 300 of FIG. 3) is open. Alternatively, the first electronic device 210 may determine whether the cover of the third electronic device 300 that has been closed gets open. A method for determining, by the first electronic device 210, whether the cover of the third electronic device 300 is open may be the same as the method in the embodiments described with reference to FIGS. 2 and 3. The method of determining whether the cover of the third electronic device 3000 that has been closed is open may determine that the cover of the third electronic device 300 that has been closed is open when the first electronic device 210 or the second electronic device 220 senses a change in magnetic force through the first sensor 211 and/or the second sensor 221.

If it is determined that the cover of the third electronic device 300 is open, the first electronic device 210 and/or the second electronic device 220 may change the first electronic device 210 and/or the second electronic device 220 to a power-on state or a wake-up mode, and may establish the first communication link between the first electronic device 210 and the second electronic device 220 if the first electronic device 210 and the second electronic device 220 are in a coupled state. If the first electronic device 210 and/or the second electronic device 220 is already in the power-on state or already in the wake-up mode, the operation of powering on the first electronic device 210 and/or the second electronic device 220 or changing to the wakeup mode may be omitted. Further, if the first electronic device 210 and the second electronic device 220 are not in the coupled state, the operation of establishing the communication link may be omitted.

If it is determined that the cover of the third electronic device 300 is open, in operation 902, the first electronic device 210 may determine whether the first electronic device 210 and the second electronic device 220 are connected to the third electronic device 300.

According to an embodiment of the disclosure, the reference to connecting the first electronic device 210 and the third electronic device 300 to each other may mean that the first electronic device 210 is inserted into the socket of the third electronic device 300 (e.g., the first socket 321 of FIG. 3). According to another embodiment of the disclosure, the reference to connecting the first electronic device 210 and the third electronic device 300 to each other may mean that the charging terminal of the first electronic device 210 (e.g., the first charging terminal 212 of FIG. 2) is electrically connected to the charging terminal of the third electronic device 300 (e.g., the third charging terminal 322 of FIG. 3). The method of determining whether the first electronic device 210 and the third electronic device 300 are connected to each other may be the same as the method in the embodiments described with reference to FIGS. 2 and 3. The first electronic device 210 may determine that it is connected to the third electronic device 300 if the voltage of the first charging terminal 212 is checked and recognized as high.

The first electronic device 210 may receive, from the second electronic device 220, information on whether the second electronic device 220 is connected to the third electronic device 300. If the first electronic device 210 and the second electronic device 220 are connected through the first communication link, the first electronic device 210 may receive information on whether the second electronic device 220 is connected to the third electronic device 300 from the second electronic device 220 through the first communication link.

If the first electronic device 210 and the second electronic device 220 are not connected through the first communication link, the third electronic device 300 may transmit, to the first electronic device 210, information on whether the second electronic device 220 is connected to the third electronic device 300, which has been received from the second electronic device 220. The communication between the third electronic device 300 and the first electronic device 210 and the communication between the third electronic device 300 and the second electronic device 220 may be power line communication (PLC) through charging terminals.

A method for determining, by the second electronic device 220, whether the second electronic device 220 and the third electronic device 300 are connected may be the same as the method for the first electronic device 210 described above.

If it is determined that the first electronic device 210 and the second electronic device 220 are connected to the third electronic device 300, then in operation 903, the first electronic device 210 may determine whether the user's touch to the first touch pad (e.g., the touch pad 170 of FIG. 1) of the first electronic device 210 and the second touch pad of the second electronic device 220 has been performed for the first time period or longer. The first electronic device 210 may receive, from the second electronic device 220, wirelessly through the first communication link or by wire through the third electronic device 300, information on whether the user's touch to the second touch pad of the second electronic device 220 has been performed for the first time period or longer. The first time period may be an arbitrary time period, and may be a time period in seconds. For example, the first time period may be 10 seconds or less, and may be 3 seconds according to an embodiment.

FIG. 9 illustrates that the first electronic device 210 determines whether the user's touch to the first touch pad and the second touch pad has been performed for the first time period or longer; however, the disclosure is not limited thereto, and the first electronic device 210 may determine whether the user's touch to at least one of the first touch pad and the second touch pad has been performed for the first time period or longer.

If it is determined that the user's touch to the first touch pad of the first electronic device 210 and the second touch pad of the second electronic device 220 has been performed for the first time period or longer, then in operation 904, the first electronic device 210 may determine whether the first electronic device 210 and the second electronic device 220 are devices coupled to each other.

The first electronic device 210 may determine whether they are coupled devices by checking a communication link connected to the second electronic device 220 or checking a Bluetooth address of the second electronic device 220. For example, when the coupled device is checked from the second electronic device 220 through the first communication link established with the second electronic device 220, the first electronic device 210 may determine that the first electronic device 210 and the second electronic device 220 are coupled devices.

Alternatively, if a Bluetooth address is stored in the first electronic device 210 as a coupled device when the first electronic device 210 is manufactured, the first electronic device 210 may determine that the first electronic device 210 and the second electronic device 220 are coupled devices by comparing the stored Bluetooth address with the address of the second electronic device 220. The comparison of the Bluetooth address of the first electronic device 210 may be performed through the first communication link or by wire through the third electronic device 300.

When it is determined that the first electronic device 210 and the second electronic device 220 are coupled devices, in operation 905, the first electronic device 210 may enter the pairing mode. As the first electronic device 210 enters the pairing mode, the mode may be changed from the inquiry scan disable mode to the inquiry scan enable mode.

In operation 906, the first electronic device 210 may transmit, to the third electronic device 300, the entry into the pairing mode. The first electronic device 210 may transmit the entry into the pairing mode to the third electronic device 300 through wired communication through the charging terminal. The third electronic device 300 may receive the entry into the pairing mode, and may notify the user of the entry into the pairing mode through a user interface device (e.g., an LED device (not shown)) included in the third electronic device 300 (e.g., LED device on).

In operation 907, the first electronic device 210 may transmit, to the third electronic device 300, a reason for terminating the pairing mode when the reason occurs. As described above, the communication between the first electronic device 210 and the third electronic device 300 may be performed through wired communication through charging terminals. According to an embodiment, the reason for terminating the pairing mode may include both a case in which pairing is completed and a case in which a predetermined time has elapsed although pairing is not completed. The third electronic device 300 may receive the termination of the pairing mode and may notify the user of the termination of the pairing mode through a user interface device (e.g., the LED device (not shown)) (e.g., the LED device off).

If the first electronic device 210 determines that the first electronic device 210 and the second electronic device 220 are not coupled devices in operation 904, then in operation 908, the first electronic device 210 may determine whether the user's touch to the first touch pad of the first electronic device 210 and the second touch pad of the second electronic device 220 has been performed for a second time period or longer. The second time period may be any time period greater than the first time period, and may be a time period in seconds. For example, the second time period may be 10 seconds or less, and may be 7 seconds according to an embodiment.

FIG. 9 illustrates that the first electronic device 210 determines whether the user's touch to the first touch pad and the second touch pad has been performed for the second time period or longer; however, the disclosure is not limited thereto, and the first electronic device 210 may determine whether the user's touch to at least one of the first touch pad and the second touch pad has been performed for the second time period or longer.

If it is determined that the user's touch to the first touch pad of the first electronic device 210 and the second touch pad of the second electronic device 220 has been performed for the second time period or longer, then in operation 909, the first electronic device 210 may enter a coupling mode with the second electronic device 220.

In operation 910, the first electronic device 210 may transmit, to the third electronic device 300, the entry into the coupling mode. As described above, the communication between the first electronic device 210 and the third electronic device 300 may be performed through wired communication through charging terminals. The third electronic device 300 may receive the entry into the coupling mode and notify the user of the entry into the coupling mode through the user interface device (e.g., an LED device (not shown)).

When coupling is completed in operation 911, the first electronic device 210 may end the process or may proceed to operation 905 to enter the pairing mode.

In operation 902 of FIG. 9, a case in which both the first electronic device 210 and the second electronic device 220 are connected to the third electronic device 300 is illustrated; however, if there is only one of the first electronic device 210 and the second electronic device 220, in a state where only one of the first electronic device 210 or the second electronic device 220 is mounted on the third electronic device 300, as the coupled counterpart electronic device is not checked, a decision as to whether to enter the pairing mode alone may be made.

For example, after checking whether the first electronic device 210 is connected to the third electronic device 300, the first electronic device 210 may determine whether a touch to the first touch pad of the first electronic device 210 has been input for the first time period or longer. If the touch to the first touch pad has been input for the first time period or longer, the first electronic device 210 may check whether the second electronic device 220, which is a coupled electronic device, is connected to the first electronic device 210. If it is determined that the second electronic device 220 is not connected to the first electronic device 210, the first electronic device 210 may check whether there is another electronic device mounted on the third electronic device 300 from the third electronic device 300. If it is determined that another electronic device other than the first electronic device 210 is not mounted on the third electronic device 300, the first electronic device 210 may enter the pairing mode alone.

Further, the operation of determining, by the first electronic device 210, in operation 903 of FIG. 9, whether the user's touch to the first touch pad and the second touch pad has been performed for the first time period or longer may be performed according to various embodiments.

After receiving from the second electronic device 220, the fact that the touch input to the second touch pad has occurred for the first time period or longer, the first electronic device 210 may determine whether the touch to the first touch pad of the first electronic device 210 has been performed for the first time period or longer.

Alternatively, the first electronic device 210 may first check the first communication link connected to the second electronic device 220 if it is determined that the touch to the first touch pad has been performed for the first time period, and then may obtain information about the touch input to the second touch pad from the second electronic device 220 through the first communication link.

According to an embodiment of the disclosure, the first electronic device 210 may check input information on the second touch pad from the second electronic device 220 if it is determined that the touch to the first touch pad has been performed for the first time period or longer, and may determine whether the touch to the first touch pad is sensed during a third time period again if the touch input to the second touch pad has not been performed for the first time period or longer. If the touch to the first touch pad is sensed for the third time period, the first electronic device 210 may check input information on the second touch pad again.

The electronic device according to various embodiments disclosed herein may be one of various types of electronic devices. The electronic devices may include, for example, a portable communication device (e.g., a smailphone), a computer device, a portable multimedia device, a portable medical device, a camera, a wearable device, or a home appliance. According to an embodiment of the present disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar or related reference numerals may be used to refer to similar or related elements. It is to be understood that a singular form of a noun corresponding to an item may include one or more of the things, unless the relevant context clearly indicates otherwise. As used herein, each of phrases such as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. Terms such as “1st” and “2nd,” or “first” and “second” may be used to simply distinguish a corresponding component from another, and do not limit the components in other aspects (e.g., importance or order). It is to be understood that if an element (e.g., a first element) is referred to, with or without the term “operatively” or “communicatively,” as “coupled with,” “coupled to,” “connected with,” or “connected to” another element (e.g., a second element), it means that the element may be coupled with the other element directly (e.g., wiredly), wirelessly, or via a third element.

As used in the present disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, the module may be implemented in a form of an application-specific integrated circuit (ASIC).

Various embodiments as set forth herein may be implemented as software (e.g., the program 140) including one or more instructions that are stored in a storage medium (e.g., the internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

A method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added.

Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a wireless communication circuit configured to perform Bluetooth communication;
a sensor;
a connection terminal configured to connect with a first external electronic device;
a processor operatively connected to the sensor and the wireless communication circuit; and
a memory operatively connected to the processor,
wherein the memory stores instructions that, when executed, cause the processor to:
determine by means of the sensor whether a cover of the first external electronic device is open,
determine whether the connection terminal is electrically connected to the first external electronic device if it is determined that the cover of the first external electronic device is open, and
switch the wireless communication circuit to an inquiry scan enable mode if it is determined that the connection terminal is connected to the first external electronic device.

2. The electronic device of claim 1, wherein the instructions further cause the processor to:
receive information about whether a second external electronic device connected to the electronic device through a first communication link using the wireless communication circuit of the electronic device is electrically connected to the first external electronic device, from the second external electronic device through a first communication link, and
switch to the inquiry scan enable mode if it is further determined that the second external electronic device is connected to the first external electronic device.

3. The electronic device of claim 1, wherein the instructions further cause the processor to receive an inquiry signal from a third external electronic device after switching to the inquiry scan enable mode, and respond to the inquiry signal if a strength of the inquiry signal is equal to or greater than a threshold value.

4. The electronic device of claim 1, wherein the instructions further cause the processor to receive an inquiry signal from a third external electronic device after switching to the inquiry scan enable mode, and respond to the inquiry signal with a signal strength that is lower than or equal to a threshold value.

5. The electronic device of claim 1,
wherein the sensor is a magnetic force sensor, and
wherein the instructions further cause the processor to determine whether the cover is open through the magnetic force sensor included in the first external electronic device.

6. The electronic device of claim 1, wherein the instructions further cause the processor to power on the electronic device if it is determined that the cover of the first external electronic device is in an open state.

7. The electronic device of claim 6, wherein the instructions further cause the processor to establish a first communication link with a second external electronic device through the wireless communication circuit after powering on the electronic device.

8. The electronic device of claim 1, wherein the instructions further cause the processor to charge a battery of the electronic device with power received from the first external electronic device through the connection terminal if the electronic device is electrically connected to the first external electronic device through the connection terminal.

9. The electronic device of claim 1, wherein the instructions further cause the processor to respond to an inquiry received from a third external electronic device, and establish a third communication link with the third external electronic device if a connection request is received from the third external electronic device.

10. An electronic device comprising:
a wireless communication circuit configured to perform Bluetooth communication;
a sensor;
a connection terminal configured to connect with a first external electronic device;
a processor operatively connected to the sensor and the wireless communication circuit; and
a memory operatively connected to the processor,
wherein the memory stores instructions that, when executed, cause the processor to:
determine by means of the sensor whether a cover of the first external electronic device is open,
determine whether the connection terminal is electrically connected to the first external electronic device if it is determined that the cover of the first external electronic device is open, and
transmit, by means of the wireless communication circuit, information about whether or not the electronic device and the first external electronic device are electrically connected to each other to a second external electronic device connected to the electronic device through a first communication link, if it is determined that the connection terminal is in a state of being connected to the first external electronic device.

11. The electronic device of claim 10, wherein the instructions cause the processor to power on the electronic device if it is determined that the cover of the first external electronic device is in an open state.

12. The electronic device of claim 11, wherein the instructions cause the processor to establish the first communication link with the second external electronic device through the wireless communication circuit after powering on the electronic device.

13. A method for operating an electronic device including a wireless communication circuit for Bluetooth communication, the method comprising:
determining by means of a sensor of the electronic device whether a cover of a first external electronic device is open;
determining whether a connection terminal of the electronic device is electrically connected to the first external electronic device if it is determined that the cover of the first external electronic device is open; and
switching to an inquiry scan enable mode if it is determined that the connection terminal is connected to the first external electronic device.

14. The method of claim 13, further comprising:
receiving, from a second external electronic device connected to the electronic device through a first communication link, information about whether or not the second external electronic device is connected to the first external electronic device; and
switching to the inquiry scan enable mode if it is further determined that the second external electronic device is connected to the first external electronic device.

15. The method of claim 13, further comprising:
receiving an inquiry from a third external electronic device after switching to the inquiry scan enable mode; and
responding to the received inquiry if a strength of a signal of the inquiry is equal to or greater than a threshold value.
